(19) United States
(12) Patent Application Publication
(10) Pub. No.: US 2021/0375072 A1
(43) Pub. Date: Dec. 2, 2021

(54) COMMUNICATION DEVICE, SYSTEM, VEHICLE, COMMUNICATION METHOD, AND PROGRAM

(71) Applicant: TOYOTA JIDOSHA KABUSHIKI KAISHA, Toyota-shi (JP)

(72) Inventor: Daiki KANEICHI, Tokyo (JP)

(73) Assignee: TOYOTA JIDOSHA KABUSHIKI KAISHA, Toyota-shi (JP)

(21) Appl. No.: 17/229,287

(22) Filed: Apr. 13, 2021

(30) Foreign Application Priority Data
May 29, 2020 (JP) 2020-094759

(51) Int. Cl. G07C 5/00; G07C 5/02

(52) U.S. Cl. CPC G07C 5/008; H04W 4/40; G07C 5/02

(57) ABSTRACT

A communication device includes: a communication unit that performs wireless communication; and a control unit that controls the communication unit such that the communication unit transmits a signal to a terminal device held by a user when determining that the user has boarded a vehicle.

### CROSS-REFERENCE TO RELATED APPLICATION

This application claims priority to Japanese Patent Application No. 2020-094759 filed on May 29, 2020, incorporated herein by reference in its entirety.

### BACKGROUND

### 1. Technical Field

The present disclosure relates to a communication device, a system, a vehicle, a communication method, and a program.

### 2. Description of Related Art

Japanese Unexamined Patent Application Publication No. 2019-041344 (JP 2019-041344 A) discloses a technique in which a mobile communication terminal transmits a boarding signal to a server when receiving a radio signal from a signal transmitter installed in a vehicle and transmits a getting-off signal to the server when no longer receiving the radio signal.

### SUMMARY

In the technique described in JP 2019-041344 A, there is a possibility that a radio signal may be received by a terminal of a user who is not in the vehicle when the terminal is located around the vehicle.

An object of the present disclosure is to make it difficult for a signal directed to a terminal of a user who is in a vehicle to be received by a terminal of a user who is not in the vehicle.

A communication device according to the present disclosure includes: a communication unit that performs wireless communication; and a control unit that controls the communication unit such that the communication unit transmits a signal to a terminal device held by a user when determining that the user has boarded a vehicle.

A communication method according to the present disclosure includes transmitting, with a communication device that performs wireless communication, a signal to a terminal device held by a user when determining that the user has boarded a vehicle.

A program according to the present disclosure causes a computer to perform an operation including performing a control of wireless communication to transmit a signal to a terminal device held by a user when determining that the user has boarded a vehicle.

According to the present disclosure, it is possible to make it difficult for a signal directed to a terminal of a user who is in a vehicle to be received by a terminal of a user who is not in the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a system according to an embodiment of the present disclosure;

FIG. 2 is a block diagram showing a configuration of a control device according to the embodiment of the present disclosure;

FIG. 3 is a block diagram showing a configuration of a terminal device according to the embodiment of the present disclosure;

FIG. 4 is a block diagram showing a configuration of a communication device according to the embodiment of the present disclosure;

FIG. 5 is a diagram showing operation of the system according to the embodiment of the present disclosure;

FIG. 6 is a flowchart showing operation of the communication device according to the embodiment of the present disclosure; FIG. 7 is a diagram showing operation of the system according to the embodiment of the present disclosure; and

FIG. 8 is a diagram showing a screen example of the terminal device according to the embodiment of the present disclosure.

### DETAILED DESCRIPTION OF EMBODIMENTS

Hereinafter, embodiments of the present disclosure will be described below with reference to the drawings.

In each figure, the same or corresponding parts are denoted by the same reference signs. In the description of the present embodiment, description of the same or corresponding parts will be appropriately omitted or simplified.

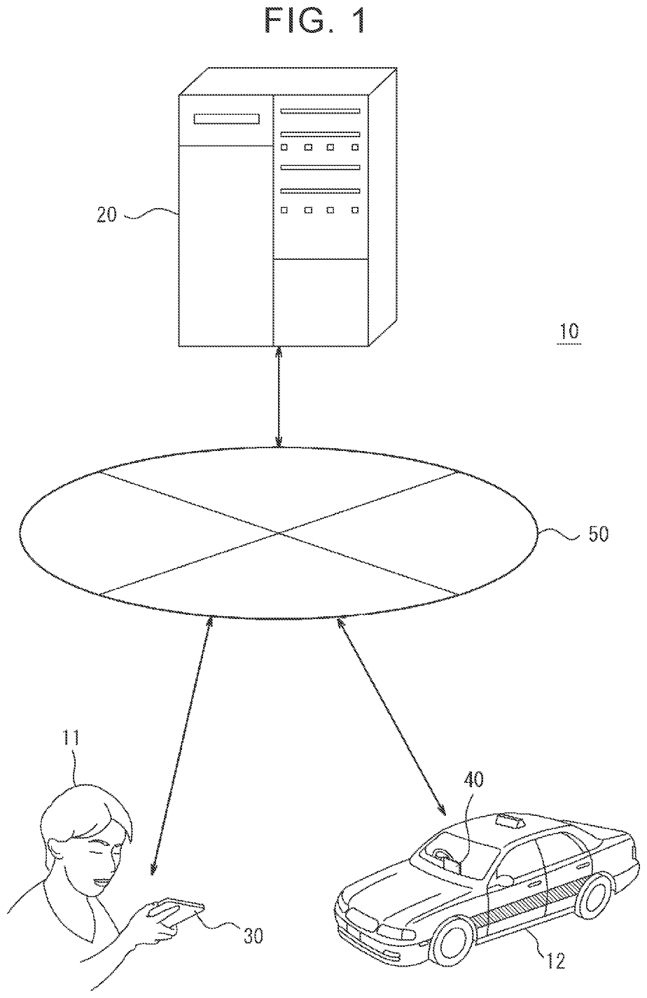

The configuration of a system 10 according to the present embodiment will be described with reference to FIG. 1.

The system 10 according to the present embodiment includes at least one control device 20, at least one terminal device 30, and at least one communication device 40.

The control device 20 can communicate with the terminal device 30 and the communication device 40 via a network 50. The terminal device 30 may be able to communicate with the communication device 40 via the network 50.

The network 50 includes the Internet, at least one WAN, at least one MAN, or a combination thereof. The term “WAN” is an abbreviation for “wide area network”. The term “MAN” is an abbreviation for “metropolitan area network”. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation for “local area network”.

The control device 20 is installed in facilities such as a data center. The control device 20 is, for example, a server belonging to a cloud computing system or other computing systems.

The terminal device 30 is held by the user 11. The terminal device 30 is, for example, a mobile device such as a mobile phone, a smartphone, or a tablet, or a PC. The term “PC” is an abbreviation for “personal computer”.

The communication device 40 is mounted or installed in a vehicle 12 such as a taxi or an on-demand bus. Alternatively, the communication device 40 is held by the driver of the vehicle 12. The communication device 40 is, for example, an in-vehicle device such as a car navigation device, a mobile device such as a mobile phone, a smartphone, or a tablet, or a PC.

The vehicle 12 is any type of vehicle, such as a gasoline vehicle, a diesel vehicle, an HV, a PHV, an EV, or an FCV. The term “HV” is an abbreviation for “hybrid vehicle”. The term “PHV” is an abbreviation for “plug-in hybrid vehicle”. The term “EV” is an abbreviation for “electric vehicle”. The term “FCV” is an abbreviation for “fuel cell vehicle”. The vehicle 12 is driven by the driver in the present embodiment, but the driving may be automated at any level. The level of autonomous driving is, for example, one of levels 1 to 5 in the SAE leveling, for example. The term “SAE” is an abbreviation for the “Society of Automotive Engineers”. The vehicle 12 may be a MaaS dedicated vehicle. The term “MaaS” is an abbreviation for “mobility as a service”.

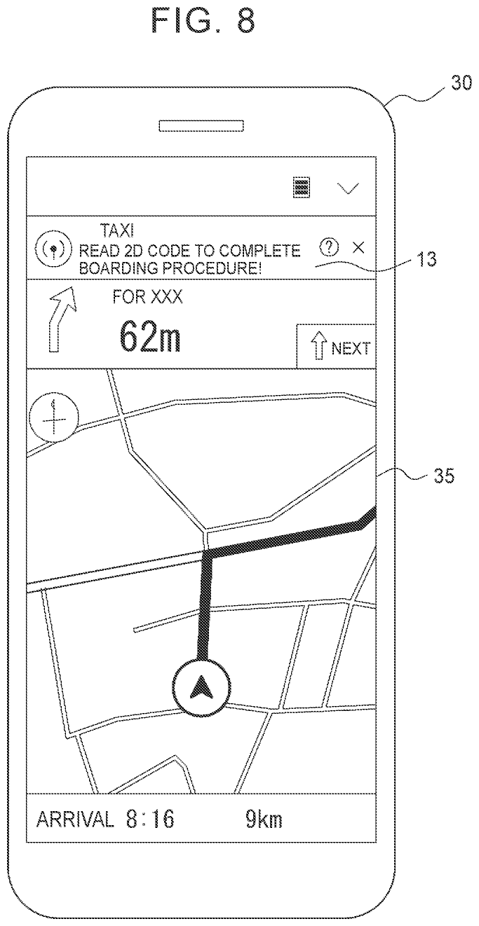

The outline of the present embodiment will be described with reference to FIGS. 1 and 8.

In the system 10 according to the present embodiment, when the communication device 40 that performs wireless communication determines that the user 11 has boarded the vehicle 12, the communication device 40 transmits a signal to the terminal device 30 held by the user 11.

According to the present embodiment, it is possible to make it difficult for a signal directed to a terminal of the user 11 who is in the vehicle 12 to be received by a terminal of a user who is not in the vehicle 12.

In the present embodiment, the terminal device 30 transmits to the control device 20 first data notifying a destination set by the user 11 together with a user identifier corresponding to the user 11. The control device 20 receives the first data from the terminal device 30.

When the communication device 40 determines that the user 11 has boarded the vehicle 12, the communication device 40 transmits a beacon, as a signal, for prompting the user 11 to perform an operation of the boarding procedure. When the terminal device 30 receives the beacon from the communication device 40, the terminal device 30 outputs a message 13 prompting the user 11 to perform the operation of the boarding procedure.

The “operation of the boarding procedure” is an operation of acquiring a vehicle identifier corresponding to the vehicle 12 that the user 11 has boarded using the terminal device 30. Examples of such an operation include an operation of pointing a camera of the terminal device 30 at a display indicating the vehicle identifier in a cabin of the vehicle 12, or an operation of holding a tag of the terminal device 30 over a reader/writer that transmits the vehicle identifier in the cabin of the vehicle 12.

The terminal device 30 acquires the vehicle identifier corresponding to the vehicle 12 that the user 11 has boarded through the operation of the boarding procedure by the user 11. The terminal device 30 transmits second data notifying the acquired vehicle identifier together with the user identifier corresponding to the user 11 to the control device 20. The control device 20 receives the second data from the terminal device 30.

The control device 20 refers to the first data and the second data having a common user identifier, and transmits destination data notifying the destination to the communication device 40. The communication device 40 receives the destination data from the control device 20.

According to the present embodiment, the information on the destination set by the user 11 can be used to set the destination in the vehicle 12 that the user 11 has boarded. For example, the communication device 40 can set the destination for car navigation, using the information on the destination for multimodal navigation, which is input to the terminal device 30 by the user 11. The term “multimodal navigation” means providing guidance on a multimodal route. The term “multimodal route” means a route that combines various means of transportation such as walk, bicycle, bus, rental car, private car, taxi, railroad, or airplane. The multimodal route may include a route that uses a taxi as the vehicle 12.

In the present embodiment, the control device 20 determines the route to the destination in accordance with the position data of the user 11 at least until the user 11 boards the vehicle 12. The control device 20 transmits route data notifying the determined route to the terminal device 30. The terminal device 30 receives the route data from the control device 20. The terminal device 30 refers to the received route data and guides the user 11 through the route to the destination. As a modification, instead of the control device 20, the terminal device 30 may determine the route through which the user 11 is guided.

After being notified of the vehicle identifier corresponding to the vehicle 12 that the user 11 has boarded, the control device 20 determines the route to the destination according to the position data of the vehicle 12. The control device 20 transmits the route data notifying the determined route to the communication device 40. The communication device 40 receives the route data from the control device 20. The communication device 40 refers to the received route data and guides the vehicle 12 through the route to the destination. As a modification, instead of the control device 20, the communication device 40 may determine the route through which the vehicle 12 is guided.

According to the present embodiment, a navigation function used by the user 11 when the user 11 is not in the vehicle 12 and a navigation function used by the driver of the vehicle 12 when the user 11 is in the vehicle 12 can be linked together. For example, information about the destination can be transferred from an application for multimodal navigation running on the terminal device 30 to an application for car navigation running on the communication device 40 of the vehicle 12 that the user 11 has boarded, via the control device 20.

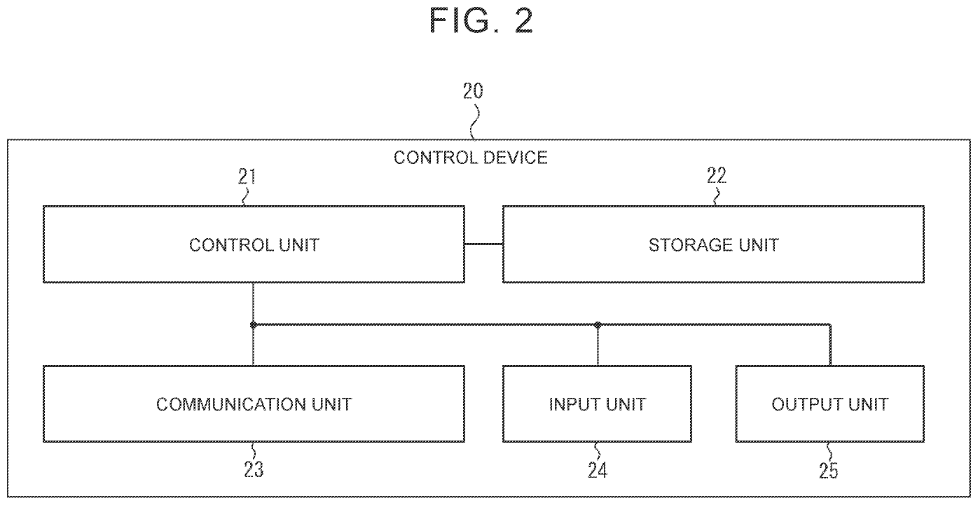

The configuration of the control device 20 according to the present embodiment will be described with reference to FIG. 2.

The control device 20 includes a control unit 21, a storage unit 22, a communication unit 23, an input unit 24, and an output unit 25.

The control unit 21 includes at least one processor, at least one dedicated circuit, or a combination thereof. The processor is a general-purpose processor such as a CPU or GPU, or a dedicated processor specialized for a specific process. The term “CPU” is an abbreviation for “central processing unit”. The term “GPU” is an abbreviation for “graphics processing unit”. The dedicated circuit is, for example, an FPGA or an ASIC. The term “FPGA” is an abbreviation for “field-programmable gate array”. The term “ASIC” is an abbreviation for “application specific integrated circuit”. The control unit 21 performs processes related to the operation of the control device 20 while controlling each unit of the control device 20.

The storage unit 22 includes at least one semiconductor memory, at least one magnetic memory, at least one optical memory, or a combination of at least two of them. The semiconductor memory is, for example, a RAM or a ROM. The term “RAM” is an abbreviation for “random access memory”. The term “ROM” is an abbreviation for “read only memory”. The RAM is, for example, an SRAM or a DRAM. The term “SRAM” is an abbreviation for “static random access memory”. The term “DRAM” is an abbreviation for “dynamic random access memory”. The ROM is, for example, an EEPROM. The term “EEPROM” is an abbreviation for “electrically erasable programmable read only memory”. The storage unit 22 functions as, for example, a main storage device, an auxiliary storage device, or a cache memory. The storage unit 22 stores data used for the operation of the control device 20 and data obtained through the operation of the control device 20.

The communication unit 23 includes at least one communication interface. The communication interface is, for example, a LAN interface. The communication unit 23 receives the data used for the operation of the control device 20, and transmits the data obtained through the operation of the control device 20.

The input unit 24 includes at least one input interface. The input interface is, for example, a physical key, a capacitive key, a pointing device, a touch screen integrated with a display, or a microphone. The input unit 24 accepts an operation of inputting data used for the operation of the control device 20. The input unit 24 may be connected to the control device 20 as an external input device instead of being provided in the control device 20. As a connection method, for example, any method such as USB, HDMI (registered trademark), or Bluetooth (registered trademark) can be used. The term “USB” is an abbreviation for “universal serial bus”. The term “HDMI (registered trademark)” is an abbreviation for “high-definition multimedia interface”.

The output unit 25 includes at least one output interface. The output interface is, for example, a display or a speaker. The display is, for example, an LCD or an organic EL display. The term “LCD” is an abbreviation for “liquid crystal display”. The term “EL” is an abbreviation for “electroluminescence”. The output unit 25 outputs the data obtained through the operation of the control device 20. The output unit 25 may be connected to the control device 20 as an external output device instead of being provided in the control device 20. As a connection method, for example, any method such as USB, HDMI (registered trademark), or Bluetooth (registered trademark) can be used.

The function of the control device 20 is realized by executing the control program according to the present embodiment with the processor corresponding to the control unit 21. That is, the function of the control device 20 is realized by software. The control program causes the computer to perform the operation of the control device 20 so that the computer functions as the control device 20. That is, the computer functions as the control device 20 by performing the operation of the control device 20 according to the control program.

The program can be stored in a non-transitory computer-readable medium. The non-transitory computer-readable medium is, for example, a magnetic recording device, an optical disc, an opto-magnetic recording medium, or a ROM. The distribution of the program is carried out, for example, by selling, transferring, or renting a portable medium such as a DVD or a CD-ROM in which the program is stored. The term “DVD” is an abbreviation for “digital versatile disc”. The term “CD-ROM” is an abbreviation for “compact disc read only memory”. The program may be stored in the storage of the server and transferred from the server to other computers to distribute the program. The program may be provided as a program product.

The computer temporarily stores the program stored in the portable medium or the program transferred from the server in the main storage device, for example. Then, the computer causes the processor to read the program stored in the main storage device, and causes the processor to perform processes according to the read program. The computer may read the program directly from the portable medium and perform processes according to the program. The computer may perform the processes according to the received program each time the program is transferred from the server to the computer. The processes may be performed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the processing of the computer corresponds to the “information equivalent to a program”.

A part or all of the functions of the control device 20 may be realized by a dedicated circuit corresponding to the control unit 21. That is, a part or all of the functions of the control device 20 may be realized by hardware.

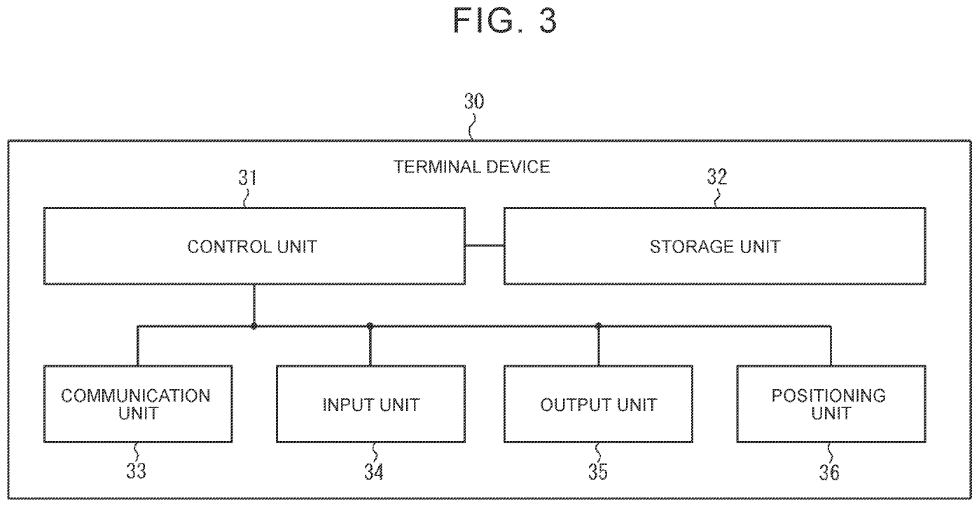

The configuration of the terminal device 30 according to the present embodiment will be described with reference to FIG. 3.

The terminal device 30 includes a control unit 31, a storage unit 32, a communication unit 33, an input unit 34, an output unit 35, and a positioning unit 36.

The control unit 31 includes at least one processor, at least one dedicated circuit, or a combination thereof. The processor is a general-purpose processor such as a CPU or GPU, or a dedicated processor specialized for a specific process. The dedicated circuit is, for example, an FPGA or an ASIC. The control unit 31 performs the processes related to the operation of the terminal device 30 while controlling each unit of the terminal device 30.

The storage unit 32 includes at least one semiconductor memory, at least one magnetic memory, at least one optical memory, or a combination of at least two of them. The semiconductor memory is, for example, a RAM or a ROM. The RAM is, for example, an SRAM or a DRAM. The ROM is, for example, an EEPROM. The storage unit 32 functions as, for example, a main storage device, an auxiliary storage device, or a cache memory. The storage unit 32 stores data used for the operation of the terminal device 30 and data obtained through the operation of the terminal device 30.

The communication unit 33 includes at least one communication interface. The communication interface is, for example, an interface compatible with mobile communication standards such as LTE, 4G, or 5G, an interface compatible with short-range wireless communication such as Bluetooth (registered trademark), or a LAN interface. The term “LTE” is an abbreviation for “long term evolution”. The term “4G” is an abbreviation for “fourth generation”. The term “5G” is an abbreviation for “fifth generation”. The communication unit 33 receives the data used for the operation of the terminal device 30, and transmits the data obtained through the operation of the terminal device 30.

The input unit 34 includes at least one input interface. The input interface is, for example, a physical key, a capacitive key, a pointing device, a touch screen integrated with a display, or a microphone. The input unit 34 accepts an operation of inputting data used for the operation of the terminal device 30. The input unit 34 may be connected to the terminal device 30 as an external input device instead of being provided in the terminal device 30. As a connection method, for example, any method such as USB, HDMI (registered trademark), or Bluetooth (registered trademark) can be used.

The output unit 35 includes at least one output interface. The output interface is, for example, a display or a speaker. The display is, for example, an LCD or an organic EL display. The output unit 35 outputs the data obtained through the operation of the terminal device 30. The output unit 35 may be connected to the terminal device 30 as an external output device instead of being provided in the terminal device 30. As a connection method, for example, any method such as USB, HDMI (registered trademark), or Bluetooth (registered trademark) can be used.

The positioning unit 36 includes at least one GNSS receiver. The term “GNSS” is an abbreviation for “global navigation satellite system”. The GNSS is, for example, GPS, QZSS, GLONASS, or Galileo. The term “GPS” is an abbreviation for “global positioning system”. The term “QZSS” is an abbreviation for “quasi-zenith satellite system”. The satellites of the QZSS are referred to as quasi-zenith satellites. The term “GLONASS” is an abbreviation for “global navigation satellite system”. The positioning unit 36 measures the position of the terminal device 30.

The function of the terminal device 30 is realized by executing the control program according to the present embodiment with the processor corresponding to the control unit 31. That is, the function of the terminal device 30 is realized by software. The terminal program causes the computer to perform the operation of the terminal device 30 so that the computer functions as the terminal device 30. That is, the computer functions as the terminal device 30 by performing the operation of the terminal device 30 according to the terminal program.

A part or all of the functions of the terminal device 30 may be realized by a dedicated circuit corresponding to the control unit 31. That is, a part or all of the functions of the terminal device 30 may be realized by hardware.

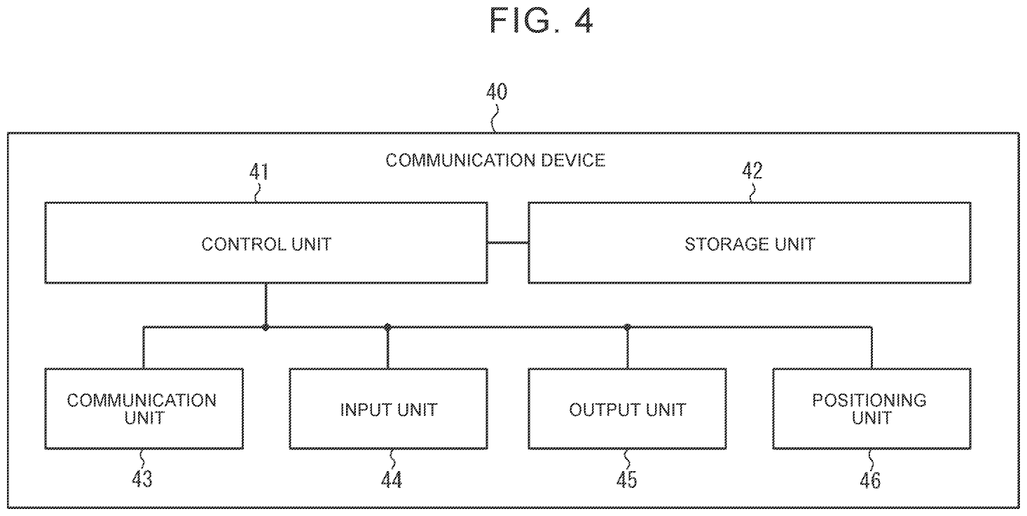

The configuration of the communication device 40 according to the present embodiment will be described with reference to FIG. 4.

The communication device 40 includes a control unit 41, a storage unit 42, a communication unit 43, an input unit 44, an output unit 45, and a positioning unit 46.

The control unit 41 includes at least one processor, at least one dedicated circuit, or a combination thereof. The processor is a general-purpose processor such as a CPU or GPU, or a dedicated processor specialized for a specific process. The dedicated circuit is, for example, an FPGA or an ASIC. The control unit 41 may include at least one ECU. The term “ECU” is an abbreviation for “electronic control unit”. The control unit 41 performs the processes related to the operation of the communication device 40 while controlling each unit of the communication device 40.

The storage unit 42 includes at least one semiconductor memory, at least one magnetic memory, at least one optical memory, or a combination of at least two of them. The semiconductor memory is, for example, a RAM or a ROM. The RAM is, for example, an SRAM or a DRAM. The ROM is, for example, an EEPROM. The storage unit 42 functions as, for example, a main storage device, an auxiliary storage device, or a cache memory. The storage unit 42 stores data used for the operation of the communication device 40 and data obtained through the operation of the communication device 40.

The communication unit 43 includes at least one communication interface. The communication interface is, for example, an interface compatible with mobile communication standards such as LTE, 4G, or 5G, an interface compatible with short-range wireless communication such as Bluetooth (registered trademark), or a LAN interface. The communication unit 43 receives the data used for the operation of the communication device 40, and transmits the data obtained through the operation of the communication device 40.

The input unit 44 includes at least one input interface. The input interface is, for example, a physical key, a capacitive key, a pointing device, a touch screen integrated with a display, or a microphone. The input unit 44 accepts an operation of inputting data used for the operation of the communication device 40. The input unit 44 may be connected to the communication device 40 as an external input device instead of being provided in the communication device 40. As a connection method, for example, any method such as USB, HDMI (registered trademark), or Bluetooth (registered trademark) can be used.

The output unit 45 includes at least one output interface. The output interface is, for example, a display or a speaker. The display is, for example, an LCD or an organic EL display. The output unit 45 outputs the data obtained through the operation of the communication device 40. The output unit 45 may be connected to the communication device 40 as an external output device such as display audio, instead of being provided in the communication device 40. As a connection method, for example, any method such as USB, HDMI (registered trademark), or Bluetooth (registered trademark) can be used.

The positioning unit 46 includes at least one GNSS receiver. The GNSS is, for example, GPS, QZSS, GLONASS, or Galileo. The positioning unit 46 measures the position of the communication device 40.

The function of the communication device 40 is realized by executing the communication program according to the present embodiment with the processor corresponding to the control unit 41. That is, the function of the communication device 40 is realized by software. The communication program causes the computer to perform the operation of the communication device 40 so that the computer functions as the communication device 40. That is, the computer functions as the communication device 40 by performing the operation of the communication device 40 according to the communication program.

A part or all of the functions of the communication device 40 may be realized by a dedicated circuit corresponding to the control unit 41. That is, a part or all of the functions of the communication device 40 may be realized by hardware.

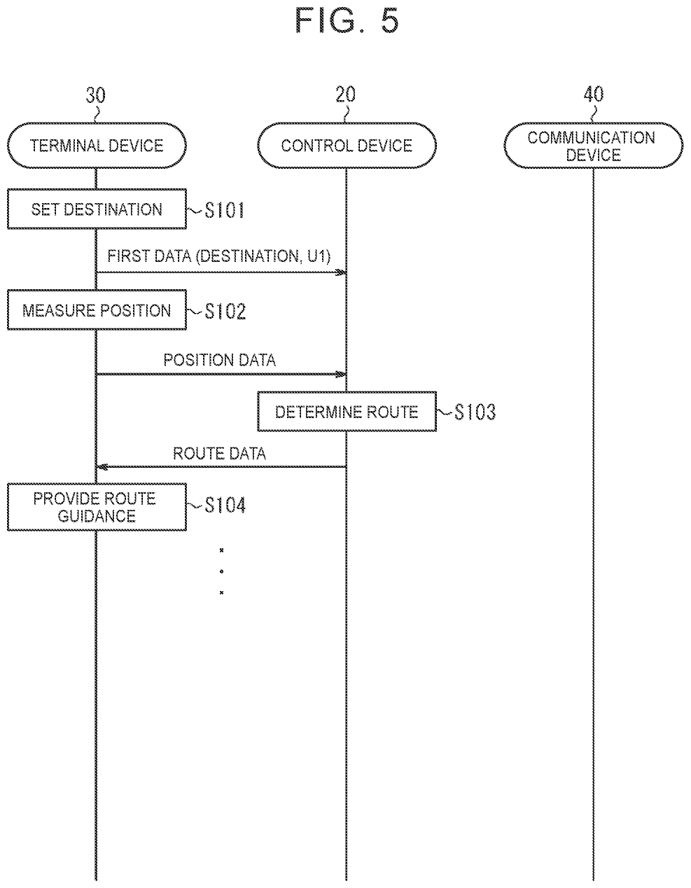

The operation of the system 10 according to the present embodiment will be described with reference to FIGS. 5, 6, and 7. The operation corresponds to the communication method according to the present embodiment.

As an example, it is assumed that the user 11 has started an application for multimodal navigation on the terminal device 30. It is assumed that the user identifier corresponding to the user 11 is “U1”. It is assumed that the vehicle identifier corresponding to the taxi serving as the vehicle 12 is “V1”.

In step S101 of FIG. 5, the control unit 31 of the terminal device 30 accepts, via the input unit 34, the operation of setting the destination by the user 11. The control unit 31 generates the first data notifying the destination set by the user 11 together with the user identifier corresponding to the user 11. The control unit 31 stores the generated first data in the storage unit 32. The control unit 31 transmits the first data stored in the storage unit 32 to the control device 20 via the communication unit 33.

In the present example, the user 11 sets the destination for multimodal navigation as a destination for the application for multimodal navigation running on the terminal device 30. The control unit 31 of the terminal device 30 notifies the control device 20 of the set destination together with the user identifier “U1”.

In step S102 of FIG. 5, the positioning unit 36 of the terminal device 30 measures the position of the terminal device 30. The control unit 31 of the terminal device 30 acquires data indicating the position measured by the positioning unit 36 as the position data of the user 11. The control unit 31 stores the acquired position data of the user 11 in the storage unit 32. The control unit 31 transmits the position data of the user 11 stored in the storage unit 32 to the control device 20 via the communication unit 33.

In the present example, the control unit 31 of the terminal device 30 acquires two-dimensional coordinates or three-dimensional coordinates of the current position of the user 11 as the position data of the user 11. The control unit 31 transmits the acquired position data of the user 11 to the control device 20 together with the user identifier “U1”.

The control unit 21 of the control device 20 receives the first data transmitted in step S101 and the position data of the user 11 transmitted in step S102, from the terminal device 30 via the communication unit 23. The control unit 21 stores the received first data and the position data in the storage unit 22. Then, in step S103 of FIG. 5, the control unit 21 determines the route to the destination notified by the first data stored in the storage unit 22, in accordance with the position data of the user 11 stored in the storage unit 22. The control unit 21 stores the route data notifying the determined route in the storage unit 22. The control unit 21 transmits the route data stored in the storage unit 22 to the terminal device 30 via the communication unit 23.

In the present example, the control unit 21 of the control device 20 refers to the map data stored in advance in the storage unit 22, and calculates a multimodal route. The multimodal route is a route starting from a point corresponding to the position data of the user 11 transmitted from the terminal device 30 together with the user identifier “U1” and reaching a destination notified by the terminal device 30 together with the user identifier “U1”. The control unit 21 notifies the terminal device 30 of the calculated multimodal route. The map data may be stored in an external system such as GIS on the Internet instead of being stored in the storage unit 22 in advance. The term “GIS” is an abbreviation for “geographic information system”.

The control unit 31 of the terminal device 30 receives the route data transmitted in step S103 from the control device 20 via the communication unit 33. The control unit 31 stores the received route data in the storage unit 32. Then, in step S104 of FIG. 5, the control unit 31 performs a control to guide the user 11 through the route notified by the route data stored in the storage unit 32. According to this control, the output unit 35 of the terminal device 30 guides, on the screen, the user 11 through the route to the destination set by the user 11.

In the present example, the control unit 31 of the terminal device 30 displays the multimodal route notified by the control device 20 on the screen of the application for multimodal navigation running on the terminal device 30.

The processes of steps S102 to S104 are repeatedly performed at least from the time when the destination is set in step S101 until the operation of step S112 of FIG. 7 is performed. As a modification, the processes of steps S102 to S104 may be stopped or terminated by a trigger such as stopping or terminating the application for multimodal navigation.

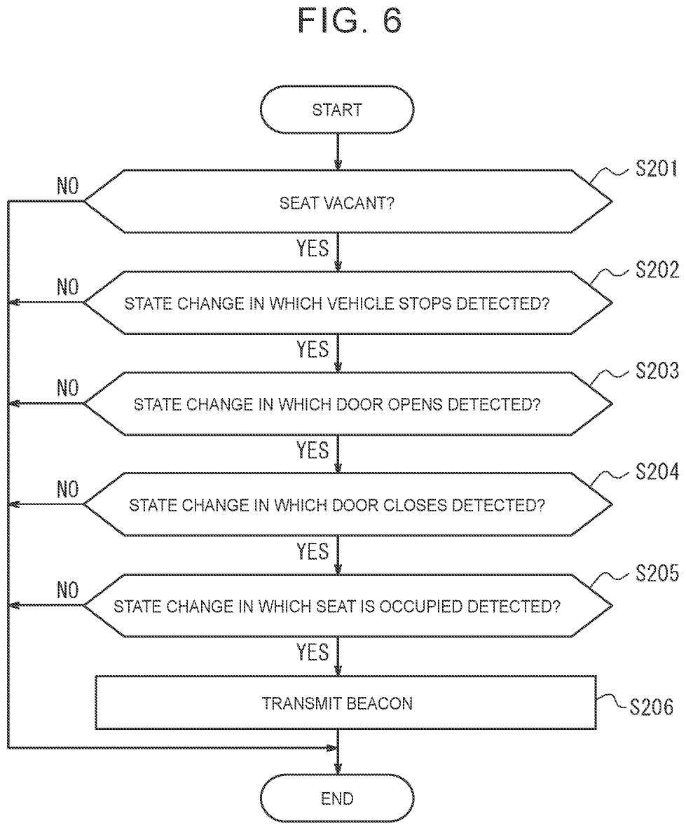

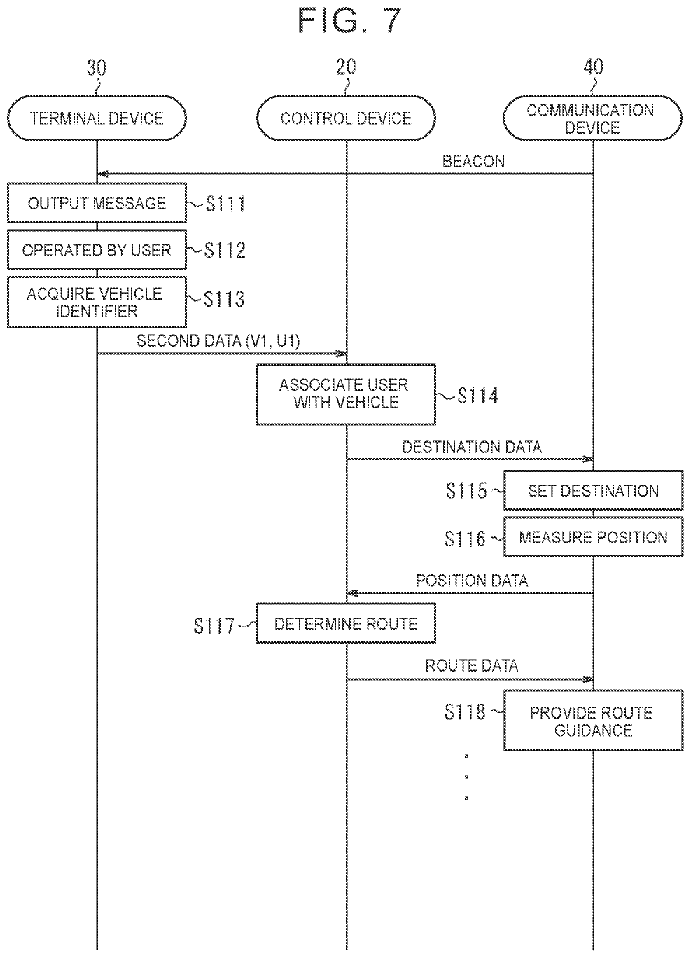

In the flow of FIG. 6, when the control unit 41 of the communication device 40 determines that the user 11 has boarded the vehicle 12, the control unit 41 controls the communication unit 43 that performs wireless communication such that the communication unit 43 transmits a signal to the terminal device 30 held by the user 11.

Specifically, in steps S201 to S205, the control unit 41 of the communication device 40 monitors at least one of the states of the vehicle 12 and the equipment of the vehicle 12. When the control unit 41 detects a certain change of state, the control unit 41 determines that the user 11 has boarded the vehicle 12. Then, in step S206, the control unit 41 controls wireless communication for transmitting a signal to the terminal device 30 held by the user 11. According to the control, the communication unit 43 transmits as a signal a beacon for prompting the user 11 to perform the operation of the boarding procedure.

In the present embodiment, the “equipment” includes seats for passengers and doors for passengers. The “seats for passengers” include at least either of rear seats and a passenger seat. When the vehicle 12 includes a number of passenger seats like a typical bus, the seats for passengers may include those seats. In the following, the “seats for passengers” will be simply referred to as “seats”. The “doors for passengers” include at least either of doors at the rear seats and a door at the passenger seat. When the vehicle 12 includes ingress/egress doors that are distanced away from the passenger seats like a typical bus, the doors for passengers may include those doors. In the following, the “doors for the passengers” will be simply referred to as “doors”.

The “change of state” includes, as a first state change, a fact that the vehicle 12 stops when the seat is vacant and the door opens after the vehicle 12 stops. The “change of state” further includes, as a second state change, a fact that the door closes after opening. The “change of state” further includes, as a third state change, a fact that the seat is occupied.

Hereinafter, details of the processes of steps S201 to S205 will be described.

In step S201, the control unit 41 determines whether the seat is vacant using a pressure sensor or a weight sensor installed in the seat or a sensor such as a camera installed in the cabin of the vehicle 12. When the seat is not vacant, the flow ends.

When the seat is vacant, in step S202, the control unit 41 determines whether there is a state change T1 in which the vehicle 12 stops by referring to the data obtained via a CAN of the vehicle 12. The term “CAN” is an abbreviation for “controller area network”. When the state change T1 is not detected, the flow ends.

When the state change T1 is detected, in step S203, the control unit 41 determines the presence or absence of a state change T2 in which the door opens, using an open/close sensor installed in the door or a sensor such as a camera installed in the cabin of the vehicle 12. When the state change T2 is not detected, the flow ends.

When the state change T2 is detected, in step S204, the control unit 41 determines the presence or absence of a state change T3 in which the door closes, using the open/close sensor installed in the door or the sensor such as a camera installed in the cabin of the vehicle 12. When the state change T3 is not detected, the flow ends.

When the state change T3 is detected, in step S205, the control unit 41 determines the presence or absence of a state change T4 in which the seat is occupied, using the pressure sensor or the weight sensor installed in the seat or the sensor such as a camera installed in the cabin of the vehicle 12. When the state change T4 is not detected, the flow ends.

When the state change T4 is detected, the control unit 41 determines that the user 11 has boarded the vehicle 12.

The combination of the state change T1 and the state change T2 following the state change T1 corresponds to the first state change. The combination of the state change T2 and the state change T3 following the state change T2 corresponds to the second state change. The state change T4 corresponds to the third state change. As a modification, the “change of state” to be detected may include only one or two of the first state change, the second state change, and the third state change, and may include other state changes.

In the present embodiment, the vehicle 12 or the communication device 40 includes a directional antenna. In step S206, the communication unit 43 transmits the beacon using this directional antenna. The beacon transmission target range is set by adjusting at least one of the position and the orientation of the directional antenna. The position of the directional antenna may be adjusted manually. Alternatively, a mechanical adjustment mechanism for displacing the directional antenna may be controlled by the control unit 41, or a plurality of directional antennas installed at different positions may be selectively operated by the control unit 41, so that the position of the directional antenna is adjusted. The orientation of the directional antenna may also be adjusted manually. Alternatively, a mechanical adjustment mechanism for turning the directional antenna may be controlled by the control unit 41, or a plurality of directional antennas installed in different orientations may be selectively operated by the control unit 41, so that the orientation of the directional antenna is adjusted.

The communication unit 43 includes the position where the seat for passenger is installed in the beacon transmission target range. That is, the communication unit 43 transmits the beacon to the position where the seat for passenger of the vehicle 12 is installed. Therefore, only the terminal of the user 11 in the vehicle 12 can receive the beacon. Further, the communication unit 43 excludes the position where the door for passenger of the vehicle 12 is installed from the beacon transmission target range. Thus, it is possible to restrain the terminal of the user who is not in the vehicle 12 from receiving the beacon.

As a modification, the control unit 41 may detect the position where the user 11 is seated using a pressure sensor or a weight sensor installed in the seat, or a sensor such as a camera installed in the cabin of the vehicle 12. The communication unit 43 may include the position detected by the control unit 41 in the beacon transmission target range. That is, the communication unit 43 may transmit the beacon to the position detected by the control unit 41.

In step S111 of FIG. 7, the communication unit 33 of the terminal device 30 receives the beacon transmitted in step S206. The beacon may be transmitted and received through any communication method, and is transmitted and received through, for example, Bluetooth (registered trademark). The control unit 31 of the terminal device 30 performs a control to output a message 13 prompting the user 11 to operate as shown in FIG. 8, when the beacon is received by the communication unit 33. According to this control, the output unit 35 of the terminal device 30 outputs the message 13 prompting the user 11 to perform the operation of the boarding procedure.

In the present example, as shown in FIG. 8, the control unit 31 of the terminal device 30 displays an icon indicating that the beacon has been received and a text message “Read the two-dimensional code to complete the boarding procedure!” on the screen of the application for multimodal navigation running on the terminal device 30.

In step S112 of FIG. 7, the terminal device 30 is operated by the user 11.

In the present example, the user 11 points the camera of the terminal device 30 at the display indicating the vehicle identifier “V1” in the cabin of the vehicle 12. The display indicates the vehicle identifier “V1” according to the control by the control unit 41 of the communication device 40. That is, the control unit 41 performs a control to indicate the vehicle identifier “V1”. As a modification, the user 11 may hold the tag of the terminal device 30 over the reader/writer that transmits the vehicle identifier “V1” in the cabin of the vehicle 12. The reader/writer transmits the vehicle identifier “V1” according to the control by the control unit 41 of the communication device 40. That is, the control unit 41 performs a control to transmit the vehicle identifier “V1”.

In step S113 of FIG. 7, the control unit 31 of the terminal device 30 acquires the vehicle identifier corresponding to the vehicle 12 through the operation of the user 11 in step S112. The control unit 31 generates the second data notifying the acquired vehicle identifier together with the user identifier. The control unit 31 stores the generated second data in the storage unit 32. The control unit 31 transmits the second data stored in the storage unit 32 to the control device 20 via the communication unit 33.

In the present example, the control unit 31 of the terminal device 30 acquires the vehicle identifier “V1” by performing a control to image the vehicle identifier “V1” displayed in the cabin of the vehicle 12. Specifically, the control unit 31 acquires the vehicle identifier “V1” by performing a control to use a camera to image the vehicle identifier “V1” displayed as a two-dimensional code. As a modification, the control unit 31 may acquire the vehicle identifier “V1” by performing a control to receive the vehicle identifier “V1” transmitted in the cabin of the vehicle 12. Specifically, the control unit 31 may acquire the vehicle identifier “V1” by performing a control to use a tag to receive the vehicle identifier “V1” transmitted via a short-range wireless communication. The control unit 31 transmits the vehicle identifier “V1” to the control device 20 together with the user identifier “U1”.

The control unit 21 of the control device 20 receives the second data transmitted in step S113 from the terminal device 30 via the communication unit 23. The control unit 21 stores the received second data in the storage unit 22. Then, in step S114 of FIG. 7, the control unit 21 refers to the first data and the second data stored in the storage unit 22 and having a common user identifier, and associates the user 11 with the vehicle 12. The control unit 21 generates the destination data notifying the destination notified by the referenced first data. The control unit 21 stores the generated destination data in the storage unit 22. The control unit 21 transmits the destination data stored in the storage unit 22 to the communication device 40 of the vehicle 12 corresponding to the vehicle identifier notified by the referenced second data via the communication unit 23. That is, the control unit 21 transmits the destination data notifying the destination set by the user 11 to the communication device 40 of the vehicle 12 associated with the user 11.

In the present example, the control unit 21 of the control device 20 notifies the communication device 40 of the vehicle 12 corresponding to the vehicle identifier “V1” transmitted from the terminal device 30 together with the user identifier “U1”, of the destination notified by the terminal device 30 together with the user identifier “U1”.

The control unit 41 of the communication device 40 receives the destination data transmitted as a result of step S114 from the control device 20 via the communication unit 43. The control unit 41 stores the received destination data in the storage unit 42. Then, in step S115 of FIG. 7, the control unit 41 sets the destination based on the destination data stored in the storage unit 42.

In the present example, the control unit 41 of the communication device 40 sets the destination notified by the control device 20 as the destination for car navigation, with respect to the car navigation application running on the communication device 40.

In step S116 of FIG. 7, the positioning unit 46 of the communication device 40 measures the position of the communication device 40. The control unit 41 of the communication device 40 acquires data indicating the position measured by the positioning unit 46 as the position data of the vehicle 12. The control unit 41 stores the acquired position data of the vehicle 12 in the storage unit 42. The control unit 41 transmits the position data of the vehicle 12 stored in the storage unit 42 to the control device 20 via the communication unit 43.

In the present example, the control unit 41 of the communication device 40 acquires two-dimensional coordinates or three-dimensional coordinates of the current position of the vehicle 12 as the position data of the vehicle 12. The control unit 41 transmits the acquired position data of the vehicle 12 to the control device 20 together with the vehicle identifier “V1”.

The control unit 21 of the control device 20 receives the position data of the vehicle 12 transmitted in step S116 from the communication device 40 via the communication unit 23. The control unit 21 stores the received position data of the vehicle 12 in the storage unit 22. Then, in step S117 of FIG. 7, the control unit 21 determines the route to the destination notified by the first data stored in the storage unit 22, in accordance with the position data of the vehicle 12 stored in the storage unit 22. The control unit 21 stores the route data notifying the determined route in the storage unit 22. The control unit 21 transmits the route data stored in the storage unit 22 to the communication device 40 via the communication unit 23.

In the present example, the control unit 21 of the control device 20 refers to the map data stored in advance in the storage unit 22, and calculates a route starting from a point corresponding to the position data of the vehicle 12 transmitted from the communication device 40 together with the vehicle identifier “V1” and reaching a destination notified by the terminal device 30 together with the user identifier “U1”. The control unit 21 notifies the communication device 40 of the calculated route.

The control unit 41 of the communication device 40 receives the route data transmitted in step S117 from the control device 20 via the communication unit 43. The control unit 41 stores the received route data in the storage unit 42. Then, in step S118 of FIG. 7, the control unit 41 performs a control to guide the driver of the vehicle 12 through the route notified by the route data stored in the storage unit 42. According to this control, the output unit 45 of the communication device 40 guides, on the screen, the driver of the vehicle 12 through the route to the destination set by the user 11.

In the present example, the control unit 41 of the communication device 40 displays the route notified by the control device 20 on the screen of the car navigation application running on the communication device 40.

The processes of steps S116 to S118 are repeatedly performed until the vehicle 12 arrives at the destination. As a modification, the processes of steps S116 to S118 may be stopped or terminated by a trigger such as stopping or terminating the car navigation application.

As described above, in the present embodiment, the communication unit 43 of the communication device 40 performs wireless communication. When the control unit 41 of the communication device 40 determines that the user 11 has boarded the vehicle 12, the control unit 41 controls the communication unit 43 such that the communication unit 43 transmits a signal to the terminal device 30 held by the user 11.

Thus, according to the present embodiment, it is possible to make it difficult for the signal directed to the terminal of the user 11 who is in the vehicle 12 to be received by a terminal of a user who is not in the vehicle 12.

The present disclosure is not limited to the embodiments described above. For example, blocks shown in the block diagrams may be integrated, or a block may be divided. Instead of executing the steps shown in the flowcharts in chronological order according to the description, the steps may be executed in parallel or in a different order, depending on the processing capacities of the devices that execute the steps, or as necessary. Other changes may be made without departing from the scope of the present disclosure.

What is claimed is:

1. A communication device comprising:
a communication unit that performs wireless communication; and
a control unit that controls the communication unit such that the communication unit transmits a signal to a terminal device held by a user when determining that the user has boarded a vehicle.

2. The communication device according to claim 1, wherein the control unit monitors at least one of states of the vehicle and equipment of the vehicle, and determines that the user has boarded the vehicle when detecting a change of state.

3. The communication device according to claim 2, wherein:
the equipment includes a seat for a passenger and a door for a passenger; and
the change of state includes a fact that the vehicle stops when the seat is vacant and the door opens after the vehicle stops.

4. The communication device according to claim 2, wherein:
the equipment includes a door for a passenger; and
the change of state includes a fact that the door closes after opening.

5. The communication device according to claim 2, wherein:
the equipment includes a seat for a passenger; and
the change of state includes a fact that the seat is occupied.

6. The communication device according to claim 1, wherein the communication unit transmits the signal using a directional antenna.

7. The communication device according to claim 6, wherein the communication unit transmits the signal to a position where a seat for a passenger of the vehicle is installed.

8. The communication device according to claim 7, wherein the seat includes a rear seat.

9. The communication device according to claim 7, wherein the seat includes a passenger seat.

10. The communication device according to claim 6, wherein the communication unit excludes a position where a door for a passenger of the vehicle is installed from a transmission target range of the signal.

11. The communication device according to claim 6, wherein:
the control unit detects a position where the user is seated; and
the communication unit transmits the signal to the position detected by the control unit.

12. The communication device according to claim 1, wherein the communication unit transmits, as the signal, a beacon for prompting the user to perform an operation of acquiring a vehicle identifier corresponding to the vehicle with the terminal device.

13. A system comprising:
the communication device according to claim 12; and
a control device that receives, from the terminal device, first data notifying a destination set by the user together with a user identifier corresponding to the user, receives second data notifying the vehicle identifier together with the user identifier from the terminal device, and refers to the first data and the second data having the user identifier common to the first data and the second data to transmit destination data notifying the destination to the communication device.

14. The system according to claim 13, further comprising the terminal device that images the vehicle identifier through the operation, wherein the control unit performs a control to display the vehicle identifier.

15. The system according to claim 13, further comprising the terminal device that receives the vehicle identifier through the operation, wherein the control unit performs a control to transmit the vehicle identifier.

16. A vehicle comprising the communication device according to claim 1.

17. A communication method comprising transmitting, with a communication device that performs wireless communication, a signal to a terminal device held by a user when determining that the user has boarded a vehicle.

18. The communication method according to claim 17, wherein transmitting the signal includes transmitting a beacon for prompting the user to perform an operation of acquiring a vehicle identifier corresponding to the vehicle with the terminal device.

19. The communication method according to claim 18, further comprising:
receiving, with a control device, first data notifying a destination set by the user together with a user identifier corresponding to the user from the terminal device;
receiving, with the control device, second data notifying the vehicle identifier together with the user identifier from the terminal device; and
referring, with the control device, to the first data and the second data having the user identifier common to the first data and the second data to transmit destination data notifying the destination to the communication device.

20. A program that causes a computer to perform an operation including performing a control of wireless communication to transmit a signal to a terminal device held by a user when determining that the user has boarded a vehicle.
